(19) United States
(12) Patent Application Publication
(10) Pub. No.: US 2009/0033674 A1
(43) Pub. Date: Feb. 5, 2009

(54) Method and apparatus for graphically defining surface normal maps

(75) Inventors: John T. Murrah, Studio City, CA (US); Donald Adolph Lusinsky, Fullerton, CA (US); Henry Allen Driskill, Valencia, CA (US); Sean D. Jenkins, Sherman Oaks, CA (US); Colin Eckart, Pasadena, CA (US); Andrew Kinney, Burbank, CA (US)

Correspondence Address: DISNEY ENTERPRISES, INC.;C/O TOWNSEND AND TOWNSEND AND CREW LLP, TWO EMBARCADERO CENTER, 8TH FLOOR, SAN FRANCISCO, CA, 94111-3834, US

(73) Assignee: Disney Enterprises, Inc., Burbank, CA (US)

(21) Appl. No.: 12/072,665

(22) Filed: Feb. 26, 2008

Related U.S. Application Data
(60) Provisional application No. 60/953,665, filed on Aug. 2, 2007.

(51) Int. Cl. G09G 5/00

(52) U.S. Cl. 345/584

(57) ABSTRACT

A surface normal map of an object can be interactively modified to create brushstroke-like textures. In one embodiment, surface normal components along the x, y, and z axes (in object coordinate space) are mapped onto red, green, and blue color components. The object's surface is displayed in an editing interface (e.g., a painting program) with colors indicating the surface normals. The user can then modify the surface normals to achieve a desired look for the object. The modified surface normals are stored with the object-model data and are used in rendering the object, helping to create a painted appearance.

### CROSS-REFERENCES TO RELATED APPLICATIONS

This application claims the benefit of U.S. Provisional Application No. 60/953,665, filed Aug. 2, 2007, entitled “Method and Apparatus for Graphically Defining Surface Normal Maps,” which disclosure is incorporated herein by reference for all purposes.

### BACKGROUND OF THE INVENTION

The present invention relates in general to computer-generated animation and in particular to graphically defining surface normal maps.

Three-dimensional (3-D) animation generally begins with a geometric model of the objects that will appear in the animated scene. Each object is modeled, e.g., as a mesh of polygons in 3-D space, and various attributes of the object's surface are associated with points in the mesh, such as the vertices of the polygons. For example, attributes associated with a point often include a color, a surface normal, a transparency parameter, reflectivity parameters, and one or more sets of texture coordinates, allowing one or more textures to be applied to the surface.

To generate (render) the images, the positions of various objects in the scene are established; for animated images, each image is generated to correspond to a particular time, and positions of at least some objects may vary with time. A viewpoint, or virtual camera position, is established, and a screen area (generally normal to the camera) is defined. The screen area is divided into small sub-areas, referred to herein as pixels, and a color for each pixel is determined based on the attributes of the object (or objects) that project onto that pixel. Which object(s) project onto a pixel can be determined using a variety of techniques, including ray-tracing. In ray tracing, rays are drawn from the pixel to the object (or from the object to the pixel), and the intersection of the ray with the object's surface determines which portion of the object's surface (e.g., which polygon or which vertices) should be used to compute the pixel's color. Computers are used extensively in both the modeling and rendering phases.

Computer-generated 3-D animation (referred to herein as “CGA”) usually approximates a photorealistic look. Objects have crisp, smooth edges and surfaces that do not bleed or smear into each other. In fact, one of the problems CGA faces is that surfaces and edges often look too smooth, lacking the roughness and imperfections of real-life objects.

Further, the photorealistic look of CGA is esthetically limiting. Traditional hand-drawn animation allows the animator to depart from a photorealistic look and adopt a more “painterly” style, with uneven brush strokes, “loose” paint at edges of objects and so on. The traditional animator can adapt the look of the animated world to fit the story being told, and this stylization is generally regarded as one of the advantages of animation over live action.

Efforts to duplicate this painterly look in CGA have not been satisfying. For instance, paintbrush textures have been applied to rendered scenes, but the result is usually a displeasing “screen door” effect as the characters and other objects move under a fixed texture. Other attempts to apply paintbrush-like textures to objects have led to distracting “popping” as loose fragments of virtual “paint” appear and disappear from one frame to the next. Some techniques for incorporating painterly elements, e.g., into backgrounds, have been developed, but these techniques generally have not scaled well or been easy to integrate into CGA processes.

It would therefore be desirable to provide improved computer-based techniques for rendering images with a painterly look.

### BRIEF SUMMARY OF THE INVENTION

In a painting, the surfaces of the objects depicted tend to include visible artifacts of the brushstrokes used to create them. For instance, edge and interior lines are generally not perfectly straight or uniform in width, curved surfaces do not look perfectly smooth or uniform, and so on. In computer generated images, such non-uniformities can be recreated by perturbing surface normal maps, but it is difficult to tell from a surface normal map what the ultimate effect of a given perturbation will be.

Accordingly some embodiments of the present invention provide visualization tools that facilitate a user's understanding of surface normal maps and the effect of making a change to a surface normal map. An intuitive visual interface allows a user (e.g., an art director, although a user could be anyone participating in the definition of an object to appear in a computer-generated image) to readily achieve a desired painterly style.

In one embodiment, the surface normal components on the x, y, and z axes (in object coordinate space) are mapped onto red, green, and blue color components, respectively. (Other mappings of surface normal components to color components may be substituted). The object's surface is displayed in an editing interface with colors indicating the surface normals. Through a graphical interface, the user can then modify the surface normals to achieve a desired look for the object. The modified surface normals are stored with the object-model data and are used in rendering the object, giving the object a painted appearance.

The following detailed description together with the accompanying drawings will provide a better understanding of the nature and advantages of the present invention.

### BRIEF DESCRIPTION OF THE DRAWINGS

FIG. 1 illustrates a reference object with surface normals represented as a color map according to an embodiment of the present invention.

FIG. 2 shows the reference object of FIG. 1 after a paintbrush-like perturbation has been applied to the RGB color components of the remapped surface normals.

FIG. 3 is a rendered image of the object of FIG. 2 after converting the perturbed RGB color component map back to a surface normal map according to an embodiment of the present invention.

FIG. 4 is a flow diagram of a process for modeling an object according to an embodiment of the present invention.

### DETAILED DESCRIPTION OF THE INVENTION

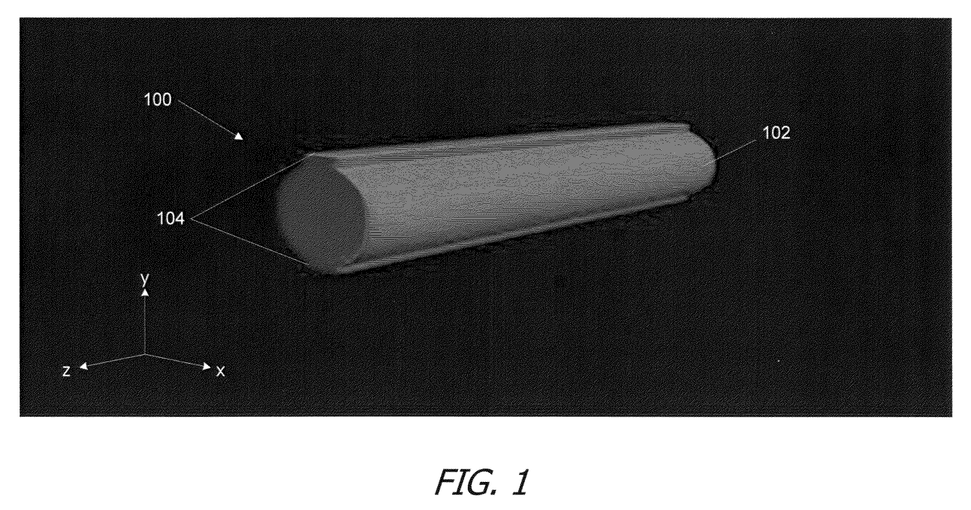

FIG. 1 illustrates a reference object 100, a cylinder 102 with flanges 104, for which surface normals are represented using a color map according to an embodiment of the present invention. In this embodiment, reference object 100 is defined in an (x, y, z) coordinate space (e.g., object space) with the axis of cylinder 102 aligned with the z axis and the y axis oriented vertically.

To aid in visualizing the surface normals, the x component of the surface normal at each point is mapped to a red color component (with higher red values reflecting larger x components), the y component to a green color component, and the z component to a blue color component. This mapping can be performed, e.g., in a paint program that allows a user (e.g., an art director) to define surface features of an object during modeling. Paint programs are known in the art. Such programs allow the user to view an image of an object, where the image is generated from the object model. A graphical user interface allows the user to rotate, zoom, and pan to see other views of the object. Further controls allow the user to modify aspects of the object model, e.g., reshaping the surface, adding additional elements, defining surface colors, etc.

In accordance with an embodiment of the present invention, the paint program can be configured with a “show surface normals” mode that maps the surface normal components to color components and uses the mapped color components to determine the color of the surface to be displayed. In this mode, color attributes defined by the object model are advantageously ignored; the color is determined using only surface normals. Thus, in “show surface normals” mode, the displayed image represents the direction of the surface normals and the variation from one portion of the object to the next.

For example, FIG. 1 shows an image that can be generated in “show surface normals” mode according to an embodiment of the present invention. In this embodiment, the x axis of an object coordinate space is mapped to the red color component, the y axis to green, and the z axis to blue. If the object model defines the surface normals as normalized vectors in object coordinate space, the mapping can be accomplished by converting each vector component (which would be in the range from −1.0 to 1.0 for a normalized vector) to an intensity value for the corresponding color component in the range between a minimum value and a maximum value (e.g., 0 to 255). Linear mapping can be used for the conversion. In some embodiments, areas near sharp edges (discontinuities in the surface normal components) can be colored to reflect a “half angle”—a color halfway between the colors associated with the surface normals on either side of the edge.

It is to be understood that the “show surface normals” mode is simply a visualization tool for of surface normals and in particular for visualizing perturbations of surface normals; in other display modes of a paint program or during actual rendering, a different surface color map can be used.

As can be seen in FIG. 1, reference object 100 has a smooth appearance, with sharp, clean edges and corners at the flanges and cylinder ends, and looks photorealistic rather than painted.

In accordance with an embodiment of the present invention, the paint program allows a user to manipulate the surface normals by manipulating the RGB color of the pixels shown in the “show surface normals mode.” In particular, the user can apply a paintbrush-like perturbation to create a more painterly appearance, with “loose” internal edges and/or corners, unevenness in curved surfaces, etc.

The surface-normal manipulation interface can be implemented in various ways. In one embodiment, “tumble and paint” interface similar to existing interfaces for manipulating images is used. The interface includes tumble tools that allow the user to modify the view of the 3-D object, so that the user can view the object from any angle, zoom in or out, etc. The interface also includes paint tools that allow the user to modify the color of the surface or a portion thereof. The paint tools advantageously provide a selection tool operable to select a portion of the surface to be modified, as well as various tools to perform modifications on the selected portion of the surface. Paint tools can include an expression-based texture manipulation tool that supports such operations as applying noise, remapping colors, warps and so on. Paint tools can also include a brush tool usable with a tablet input device or the like that supports painting or blending user-selected colors onto a surface; painted textures can be projected back onto the surface and stored as texture maps using conventional techniques. More generally, any paint tool that allows a user to modify the coloration of a surface can be used.

In some embodiments, the interface also provides a preview mode, in which the artist can see the object rendered with the modified surface normals. This mode allows the user to see directly the effect of the surface normal manipulations on lighting of the object.

Thus, the artist can begin with an image colored according to the initial surface normal map and can select and blend between colors to make adjustments. The user can then operate the tumble tool to change to a new view of the surface and continue painting. This process can be repeated until the user is satisfied.

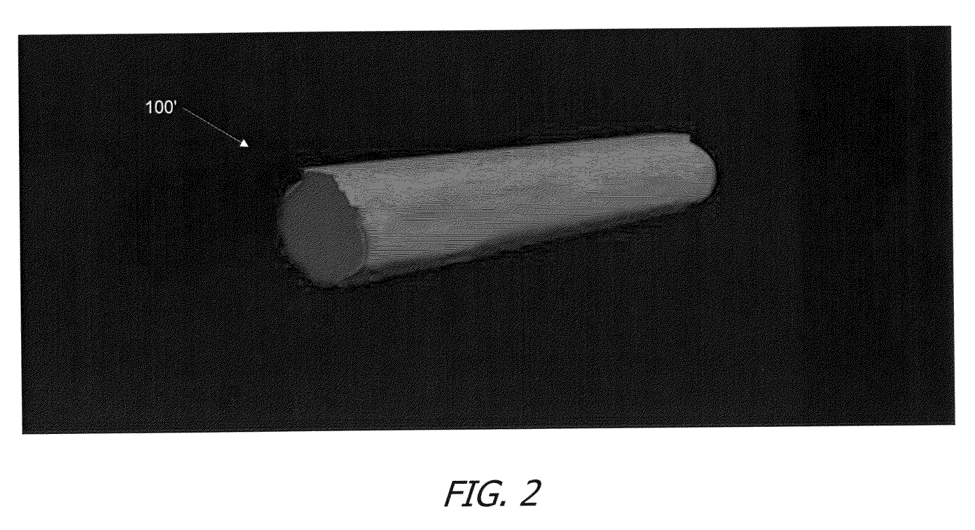

Because it is color that changes as the user manipulates the object, the effect of the change is readily apparent. For example, FIG. 2 shows reference object 100′, which corresponds to reference object 100 of FIG. 1 except that a paintbrush-like perturbation has been applied to the RGB color components according to an embodiment of the present invention. The appearance of the object in FIG. 2 is decidedly more painterly than that in FIG. 1.

Once the user is satisfied that the desired style has been achieved for the object, the modified RGB color components can be used to create a new surface normal map, e.g., by mapping the R, G, and B color components back to x, y and z components of a surface normal vector at a number of different points on the surface. (The inverse of the mapping transformation that was employed to generate the image shown in FIG. 1 can be used here.) The new surface normal map is stored with the rest of the geometry model for the object.

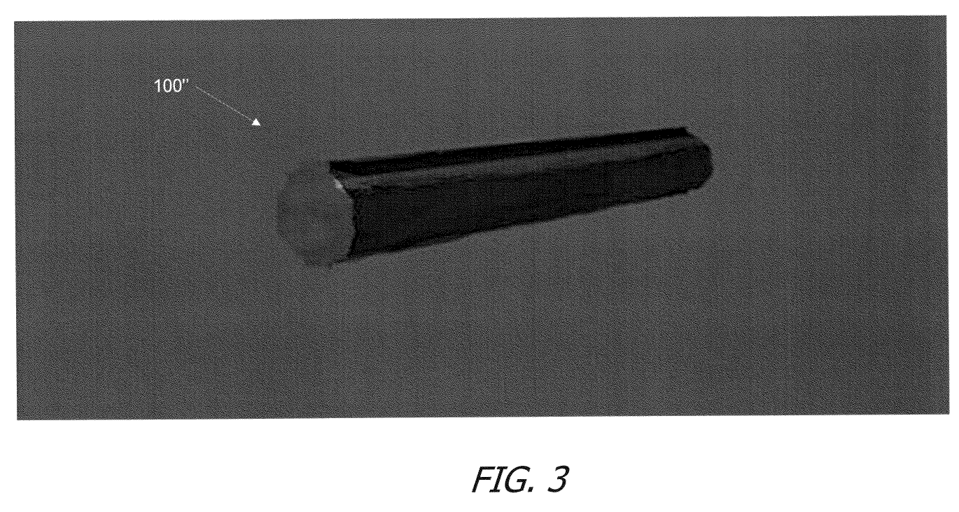

The object can then be rendered using conventional techniques. FIG. 3 is an image of a reference object 100″. The image in FIG. 3 is generated by converting the modified RGB surface normal map of FIG. 2 back to surface normal components, then rendering surface lighting using the surface normal map. Although surface coloring has not been applied, the shading of object 100″ does reflect highlights and shadows rendered in accordance with the modified surface normal map of FIG. 2. As FIG. 3 shows, the surface of rendered object 100″ takes on a painterly quality as a result of the modifications to the surface normal map.

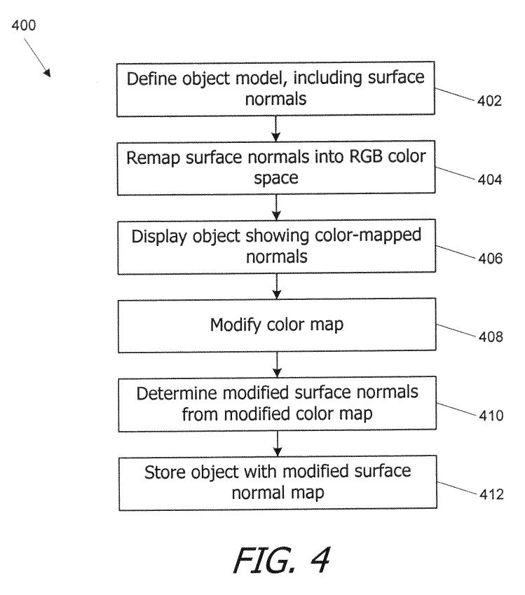

FIG. 4 is a flow diagram of a process 400 for modeling an object with painterly surface normals according to an embodiment of the present invention. Process 400 can be performed, e.g., using a paint program of generally conventional design augmented with additional capabilities related to surface normal mapping as described herein. At step 402, an object model is defined. The object model includes a surface normal map from which a surface normal at any point on the object's surface can be determined. The surface normal map can be a high-resolution map as is commonly used for generating cinematic images. Conventional mapping techniques may be used to represent the surface normals as a function of position. For instance, a surface normal can be associated with each vertex of a polygon mesh, with surface normals for intermediate points being determined by interpolation. Alternatively, a parametric mapping that defines surface normals as a function of (x, y, z) position in the object's coordinate space can be used. At this stage, the surface normals can be smoothly varying or otherwise appropriate for photorealistic objects.

At step 404, the surface normal map is remapped into RGB color space. Remapping can include, e.g., associating the (normalized) x, y and z components of the surface normal with red, green, and blue intensities, respectively, as described above. At step 406, an image of the object is displayed in the paint program, with the surface of the object being colored according to the RGB color map representing the surface normals, resulting in an image such as that shown in FIG. 1. This enables a user of the paint program to see the variation in surface normals and readily judge the smoothness and evenness of the surface.

At step 408, the user can modify the RGB color map. For example, the user can apply a perturbation to the colors that emulates the unevenness of a paintbrush stroke as shown in FIG. 2. The perturbation can be parametric, noise-based, based on predefined brush stroke patterns, or improvised by the user on the spot using the paint program to change pixel colors while viewing the image of the object until a desired quality of unevenness is achieved. The paint program's painting interface can be used to allow the user to alter colors for a pixel or swath of pixels. At step 410, when the user has finished modifying the RGB color map, the color map is converted back into a modified surface normal map. The inverse of the mapping at step 404 can be used.

At step 412, the modified surface normal map is stored in association with the object. The object can then be rendered using the modified surface normal map. The modifications to the surface normals affect the lighting of the surface as is known in the art, and as a result, the object has a less perfectly round, more brush-stroked appearance, e.g., as shown in FIG. 3. In an alternative embodiment, the modified surface normal map can be used directly in image rendering rather than being stored first.

While the invention has been described with respect to specific embodiments, one skilled in the art will recognize that numerous modifications are possible. For example, the mapping of (x, y, z) to RGB color space could be changed, e.g., by mapping x, y, and z components to a different permutation of the red, green and blue color components, or by mapping into a different color space (e.g., the “negative” cyan, magenta, yellow space). Other procedural perturbation techniques could be used to perturb or modify surface normals in addition to or instead of the specific techniques described herein. The processes and techniques described herein can be used more generally to manipulate the surface normal map on a high-resolution object model to achieve treatments other than that shown, in order to achieve other particular artistic stylizations of the object.

It should be noted that surface normal perturbation as described herein will generally affect the appearance of non-silhouette portions of an object, in particular non-silhouette edges or curved surfaces. The surface normal perturbation generally has less effect on silhouette edges, where the surface normal is approximately at right angles to the viewer. This can be seen, e.g., in FIG. 3. It is to be understood that the present invention can be employed in conjunction with other techniques, such as the multiple-surface rendering techniques described in commonly-owned co-pending U.S. Provisional Patent Application No. ______ (Attorney Docket No. 026231-002310US), filed of even date herewith, can be used in connection with the present invention to provide a more painterly look at or near silhouette edges. For example, multi-surface rendering can be used to create an appearance of loose paint at or near the silhouette edges.

Some components of the processes described herein can be implemented using suitably-configured computer systems. Such systems may be of conventional design and may include standard components such as microprocessors, monitors, keyboards, mice, magnetic disk drives, CD or DVD drives, flash drives, network interface components, and the like. In addition, interconnected groups of computers (e.g., server farms) may be used to practice aspects of the present invention. While the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded on various computer readable storage media; suitable media include magnetic disk or tape, optical storage media such as CD or DVD, flash memory, and the like. Such programs may also be encoded and transmitted using carrier signals adapted for transmission via wired, optical, and/or wireless networks conforming to a variety of protocols, including the Internet. Computer readable media encoded with the program code may be packaged with a compatible device or provided separately from other devices (e.g., via Internet download to a storage medium connected to the recipient's computer system).

Thus, although the invention has been described with respect to specific embodiments, it will be appreciated that the invention is intended to cover all modifications and equivalents within the scope of the following claims.

What is claimed is:

1. A method for modeling an object with a painterly appearance, the method comprising:
obtaining an initial object model, the initial object model including a surface normal map defining a surface normal vector at each of a plurality of points on a surface of the object;
translating the surface normal map into a color component map;
displaying an image of the object wherein a color for each visible portion of the object is determined from the color component map;
receiving user input specifying a modification to the color component map;
modifying the color component map in response to the user input;
updating the displayed image using the modified color component map;
modifying the surface normal map using the modified color component map; and
storing the modified surface normal map in a memory of a computer system.

2. The method of claim 1 wherein translating the surface normal map into a color component map includes applying a mapping function that maps components of the surface normal vector to color components in a color space.

3. The method of claim 2 wherein the color space is a red, green, blue color space.

4. The method of claim 1 wherein the received user input specifies a perturbation to be applied to the color map.

5. The method of claim 4 wherein the perturbation is a noise-based perturbation.

6. The method of claim 4 wherein the perturbation is a predefined perturbation pattern.

7. The method of claim 1 wherein the received user input specifies a manual modification to a color of one or more pixels in the displayed image.

8. The method of claim 1 further comprising:
using the modified surface normal map during a rendering operation that produces image data for the object.

9. The method of claim 8 further comprising:
storing the image on a storage medium.

10. The method of claim 9 wherein the storage medium comprises film.

11. The method of claim 9 wherein the storage medium comprises a computer readable storage medium that stores a digital representation of the image.

12. The method of claim 9 further comprising:
displaying the image.

13. A computer program product comprising a computer readable storage medium encoded with program code for controlling operation of a computer system, the program code including:
program code for translating a surface normal map of an object into a color component map;
program code for displaying an image of the object wherein a color for each visible portion of the object is determined from the color component map;
program code for modifying the color component map in response to a user input specifying a modification to be made;
program code for updating the displayed image using the modified color component map;
program code for modifying the surface normal map using the modified color component map; and
program code for storing the modified surface normal map in a memory of a computer system.

14. The computer program product of claim 13 wherein the program code further includes:
program code for modifying a view of the object in response to a user input specifying a change in the view of the object; and
program code for displaying the object in the modified view.

15. The computer program product of claim 13 wherein the program code further includes:
program code for receiving a user input requesting a preview image of the object; and
program code for generating the preview image of the object, the program code including program code for using the modified color component map to generate a temporary surface normal map to be used in generating the preview image.

16. The computer program product of claim 13 wherein the program code further includes:
program code for providing a user interface including an expression editor operable by the user to specify a modification to be made to the color component map.

17. The computer program product of claim 13 wherein the program code further includes:
program code for providing a user interface including a brush tool operable by the user to modify a visible region on the image of the object.
